(19) United States
(12) Patent Application Publication
(10) Pub. No.: US 2026/0023651 A1
(43) Pub. Date: Jan. 22, 2026

(54) DATA RECONSTRUCTION BY A MEMORY SYSTEM

(71) Applicant: Micron Technology, Inc., Boise, ID (US)

(72) Inventors: Giuseppe Cariello, Boise, ID (US); Paul Henry Chandler Smith, Boise, ID (US)

(21) Appl. No.: 19/258,692

(22) Filed: Jul. 2, 2025

Related U.S. Application Data
(60) Provisional application No. 63/672,173, filed on Jul. 16, 2024.

(51) Int. Cl. G06F 11/10

(52) U.S. Cl. CPC G06F 11/1088

(57) ABSTRACT

Methods, systems, and devices for data reconstruction by a memory system are described. A memory system may receive a write command and store the data to a write buffer. The memory system may generate parity bits associated with the data, write the data to one or more non-volatile memory cells, and erase the data from the write buffer. If a programming error occurs when writing the data to the non-volatile memory cells, the portion of the data associated with the error may be reconstructed by performing a logical operation on a portion of the data successfully written and the parity bits. The reconstructed portion of the data may be written to the one or more non-volatile memory cells.

### CROSS REFERENCE

The present Application for Patent claims priority to U.S. Patent Application No. 63/672,173 by Cariello et al., entitled “DATA RECONSTRUCTION BY A MEMORY SYSTEM,” filed Jul. 16, 2024, which is assigned to the assignee hereof, and which is expressly incorporated by reference in its entirety herein.

### TECHNICAL FIELD

The following relates to one or more systems for memory, including data reconstruction by a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data reconstruction by a memory system in accordance with examples as disclosed herein.

FIG. 2 shows an example of a timing diagram that supports data reconstruction by a memory system in accordance with examples as disclosed herein.

FIG. 3 shows an example of a process that supports data reconstruction by a memory system in accordance with examples as disclosed herein.

FIG. 4 shows a block diagram of a memory system that supports data reconstruction by a memory system in accordance with examples as disclosed herein.

FIG. 5 shows a flowchart illustrating a method or methods that support data reconstruction by a memory system in accordance with examples as disclosed herein.

### DETAILED DESCRIPTION

Some memory systems may include error detection and correction capabilities. For example, some memory systems may include a redundant array of independent NAND (RAIN) where parity pages or codewords are associated with sets of data and stored to rebuild missing data when one a storage location is affected by an error (e.g., an unrecoverable error). However, in some examples, it may be sufficient (e.g., based on the memory system's reliability level) to recover only program failures. That is, if the data is being written (e.g., programmed) to the memory system and an error occurs, the memory system may be able to retrieve the data to a buffer (e.g., to an internal buffer) and reprogram the data to a different location. In such an example, data may be stored to the buffer until the programming operation is complete. In other examples, it may be desirable to release the data from the buffer after the data is transferred to the NAND in order to receive additional data from the host system to support performance requirements. Because buffer space is both limited and expensive, the memory system may not include the requisite buffer space to store data to correct programming errors. Accordingly, a memory system configured to detect and correct programming errors while utilizing minimal buffer space may be desirable.

A memory system configured to detect and correct programming errors while utilizing less buffer space is described herein. If a memory system receives a programming command (e.g., a write command), the data may be temporarily stored in a write buffer and parity bits (e.g., RAIN parity bits) associated with the data may be generated. Once the parity bits are generated, and the data is transferred (e.g., flushed) from the write buffer to non-volatile memory, the buffer may be released in order to receive new (e.g., additional) data. The parity bits may be maintained until the data is successfully written. If an error occurs during a programming operation, the parity bits may be used to reconstruct the portion of the data that experienced the error. For example, if a first portion of the data experienced an error, the first portion may be reconstructed by performing a logical operation (e.g., a XOR operation) on the portion of the data that was successfully programmed to the non-volatile memory and the parity bits. After recovering first portion of the data, it may be written (e.g., for a second time) and the parity bits may be erased. Accordingly, the memory system may detect and correct programming errors, which may improve its overall performance, without occupying a relatively large buffer space for a relatively long duration.

In addition to applicability in memory systems as described herein, techniques for data reconstruction by a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by correcting programming errors, which may decrease processing or latency times, improve response times, or otherwise improve user experience, among other benefits.

In addition to applicability in memory systems described herein, techniques for data reconstruction by a memory system may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by correcting programming errors and may prevent or mitigate unauthorized access to data or other information, among other benefits.

Features of the disclosure are illustrated and described in the context of a system. Features of the disclosure are further illustrated and described in the context of timing diagrams, processes, block diagrams, and flowcharts.

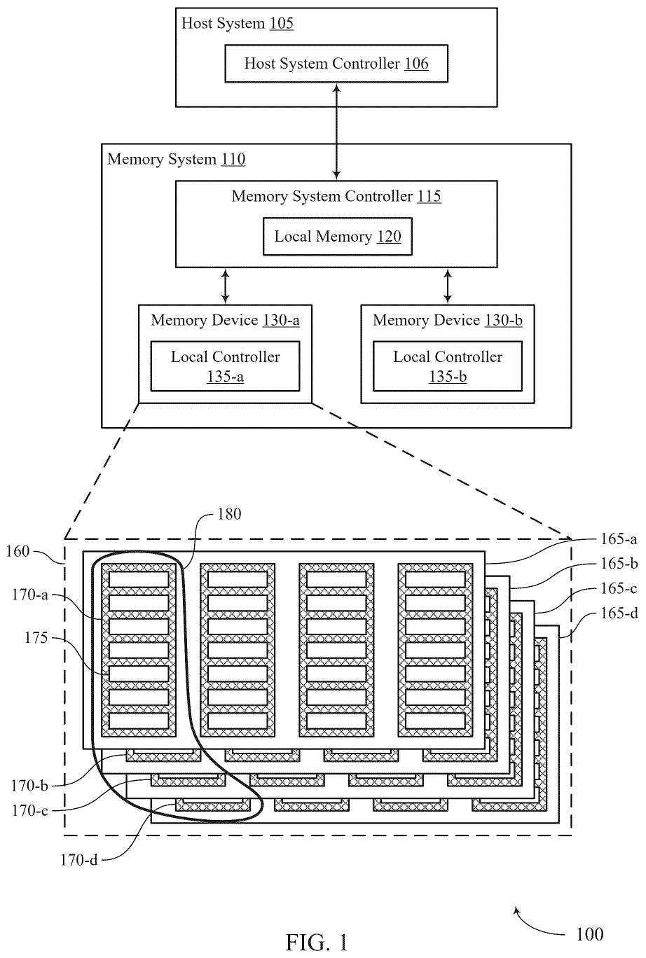

FIG. 1 shows an example of a system 100 that supports data reconstruction by a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may be configured to detect and correct programming errors while utilizing less buffer space. If the memory system 110 receives a programming command (e.g., a write command) from the host system 105, the data may be temporarily stored in a write buffer (e.g., the local memory 120) and parity bits (e.g., RAIN parity bits) associated with the data may be generated. Once the parity bits are generated, and the data is be moved (e.g., flushed) from the write buffer to the memory device 130-a, the write buffer can be released to receive new (e.g., additional data). The parity bits may be maintained until the data is successfully written. If an error occurs during a programming operation, the parity bits may be used to reconstruct the portion of the data that experienced the error. For example, if a first portion of the data experienced an error, the memory system controller 115 may reconstruct the first portion by performing a logical operation (e.g., a XOR operation) on the portion of the data that was successfully programmed and the parity bits. After recovering first portion of the data, the memory system controller 115 may write the first portion of the data to the memory device 130-a (e.g., for a second time) and erase the parity bits. Accordingly, the memory system 110 may detect and correct programming errors, which may improve its overall performance, without occupying a relatively large buffer space for a relatively long duration.

The system 100 may include any quantity of non-transitory computer readable media that support data reconstruction by a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

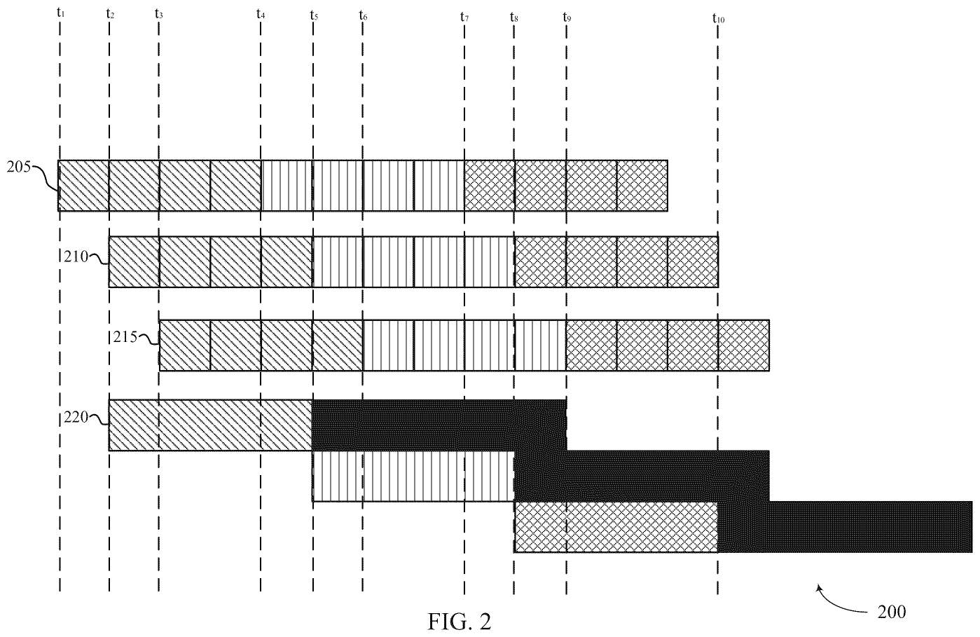

FIG. 2 shows an example of a timing diagram 200 that supports data reconstruction by a memory system in accordance with examples as disclosed herein. In some examples, the timing diagram 200 may illustrate aspects of operating the memory system 110 as described with reference to FIG. 1. For example, the timing diagram 200 may illustrate operations performed at a command bus 205, a write buffer 210, a cache 215, and a parity buffer 220. In some examples, the timing diagram 200 may be associated with a memory system that can detect and correct programming errors, which may improve its overall performance, without occupying a relatively large buffer space for a relatively long duration.

In some examples, command bus 205 may be an example of a UFS bus 205 or another type of bus configured to receive commands from a host system (e.g., a host system 105 as described with reference to FIG. 1). For example, a memory system may receive write commands via the command bus 205 and may store data associated with the write commands to the write buffer 210. In some instances, the write buffer 210 may be an example of the local memory 120 as described with reference to FIG. 1. Additionally, or alternatively, data may be temporarily stored to the write buffer 210 and written to the non-volatile memory device 130 as described with reference to FIG. 1. In some memory systems, data may be maintained in a write buffer 210 until it is successfully transferred (e.g., programmed, written to) to the cache 215, and then to the non-volatile memory device 130.

Once the data is successfully transferred, both the associated parity bits and data stored to the write buffer 210 may be released (e.g., erased). During periods of time where many write operations are ongoing, or during periods of time where relatively large write operations are being performed, the write buffer 210 may become full of data that has been successfully transferred but not yet released, which is undesirable. The memory system described herein may be configured to detect and correct programming errors, which may improve its overall performance, without occupying a relatively large write buffer 210 space for a relatively long duration.

In some instances, the associated memory system may also include a parity buffer 220. The parity buffer 220 may be a dedicated buffer (e.g., a hardware component dedicated for storing parity bits) or may occupy a portion of the local memory 120 as described with reference to FIG. 1. As described herein, the generated parity bits may be stored to the parity buffer 220 until the associated data is successfully written to the non-volatile memory device 130.

At time t₁, a write command may be received. In some examples, the write command may be received via the command bus 205 and may include data to be written to one or more non-volatile memory cells of the non-volatile memory device 130. In some instances, the write command may be received via an interface of the memory system and may be received from a host system.

At time t₂, the received data may be stored to the write buffer 210. At time t₂, parity information (e.g., a set of parity bits) associated with the data may also be generated while data associated with the write command is received via the command bus 205. For example, once the data is received, the memory system controller (e.g., the memory system controller 115 as described with reference to FIG. 1) may transfer the data to the write buffer 210 and may begin generating a set of parity bits associated with the data. In other examples, another component (e.g., an error control component) may generate the parity bits. The data may be continually moved (e.g., stored) to the write buffer 210 as it is received, and parity bits may be generated and stored to the parity buffer 220 as the data is received.

At time t₃, data stored to the write buffer 210 may be transferred (e.g., flushed) to the cache 215 of a non-volatile memory device 130. At time t₃, the received data may also be stored to the write buffer 210 and parity information (e.g., a set of parity bits) associated with the data may also be generated while data associated with the write command is received via the command bus 205. For example, once a portion of the data is stored to the cache 215, the memory system controller may write the data to the non-volatile memory device 130. Maintaining data in the write buffer 210 for a relatively short duration may allow for the write buffer 210 to be relatively small, which may lower the cost or shrink the overall footprint of the associated memory system.

Moreover, at time t₃, data may still be received via the command bus 205 and the memory system controller may transfer the data to the write buffer 210 and continue generating the set of parity bits associated with the data. The data may be continually moved (e.g., stored) to the write buffer 210 as it is received, and parity bits may be generated and stored to the parity buffer 220 as the data is received.

At time t₄, the write command may be received (e.g., fully received, completely received) and a second write command may be received. In some examples, the second write command may be received via the command bus 205 and may include second data to be written to one or more non-volatile memory cells of the non-volatile memory device 130. The second write command may be received while a portion of the data is still in the write buffer 210, while a portion of the data is still being written to the non-volatile memory device 130, and while a portion of the parity bits are still being generated at the parity buffer 220.

At time t₅, the received second data may be stored to the write buffer 210 while a last portion of the data is being written to the non-volatile memory device 130 (e.g., while at least a portion of the data is being transferred from the cache 215 to the non-volatile memory device 130). At time t₅, parity information (e.g., a second set of parity bits) associated with the second data may also be generated while data associated with the second write command is received via the command bus 205. For example, once the second data is received, the memory system controller may transfer the second data to the write buffer 210 and may begin generating a second set of parity bits associated with the second data. At time t₅, the data may be fully released from the write buffer 210.

In other examples, another component (e.g., an error control component) may generate the second set of parity bits. The second data may be continually moved (e.g., stored) to the write buffer 210 as it is received, and the second set of parity bits parity bits may be generated and stored to the parity buffer 220 as the data is received. Additionally, or alternatively, the previously generated set of parity bits may be maintained (e.g., stored) at the parity buffer 220 during t₅, when the array operation starts, until to when the array operation ends and a result of the operation (e.g., whether the operation is successful or unsuccessful) is obtained.

At time t₆, second data stored to the write buffer 210 may be moved (e.g., written) to the cache 215 of the non-volatile memory device 130. At time t₆, the received second data may also be stored to the write buffer 210 and parity information (e.g., a second set of parity bits) associated with the second data may also be generated while second data associated with the second write command is received via the command bus 205. For example, once a portion of the second data is stored to the cache 215, the memory system controller may write the second data to the non-volatile memory device 130. Moreover, at time t₆, second data may still be received via the command bus 205 and the memory system controller may transfer the second data to the write buffer 210 and continue generating the second set of parity bits associated with the second data. The second data may be continually moved (e.g., stored) to the write buffer 210 as it is received, and the second set of parity bits parity bits may be generated and stored to the parity buffer 220 as the second data is received.

At time t₇, the second write command may be received (e.g., fully received, completely received) and a third write command may be received. In some examples, the third write command may be received via the command bus 205 and may include third data to be written to one or more non-volatile memory cells of the non-volatile memory device 130. The third write command may be received while a portion of the second data is still in the write buffer 210, while a portion of the second data is still being written to the non-volatile memory device 130, and while a portion of the second set of parity bits are still being generated at the parity buffer 220.

At time t₈, the received third data may be stored to the write buffer 210 while a last portion of the second data is being written to the non-volatile memory device 130 (e.g., while at least a portion of the second data is being transferred from the cache 215 to the non-volatile memory device 130). At time t₈, parity information (e.g., a third set of parity bits) associated with the third data may also be generated while data associated with the third write command is received via the command bus 205. For example, once the third data is received, the memory system controller may transfer the third data to the write buffer 210 and may begin generating a third set of parity bits associated with the third data. At time t₈, the second data may be fully released from the write buffer 210.

In other examples, another component (e.g., an error control component) may generate the third set of parity bits. The third data may be continually moved (e.g., stored) to the write buffer 210 as it is received, and the third set of parity bits parity bits may be generated and stored to the parity buffer 220 as the data is received. Additionally, or alternatively, the previously generated set of parity bits may be maintained (e.g., stored) at the parity buffer 220 during t₈, when the array operation starts, until the array operation ends and a result of the operation (e.g., whether the operation is successful or unsuccessful) is obtained

At time t₉, the first data may have been moved (e.g., successfully written) to the non-volatile memory device 130 and the associated parity buffer 220 may have been released. At time t₉, the received second data, waiting in the program cache 215 might start to be programmed to the non-volatile memory device 130. Moreover, at time t₉, third data may start to be moved to the cache 215. The third data may be continually moved (e.g., stored) to the cache 215 as it is received in the write buffer 210, and the third set of parity bits parity bits may be updated (e.g., moved) to the parity buffer 220 as the third data is received.

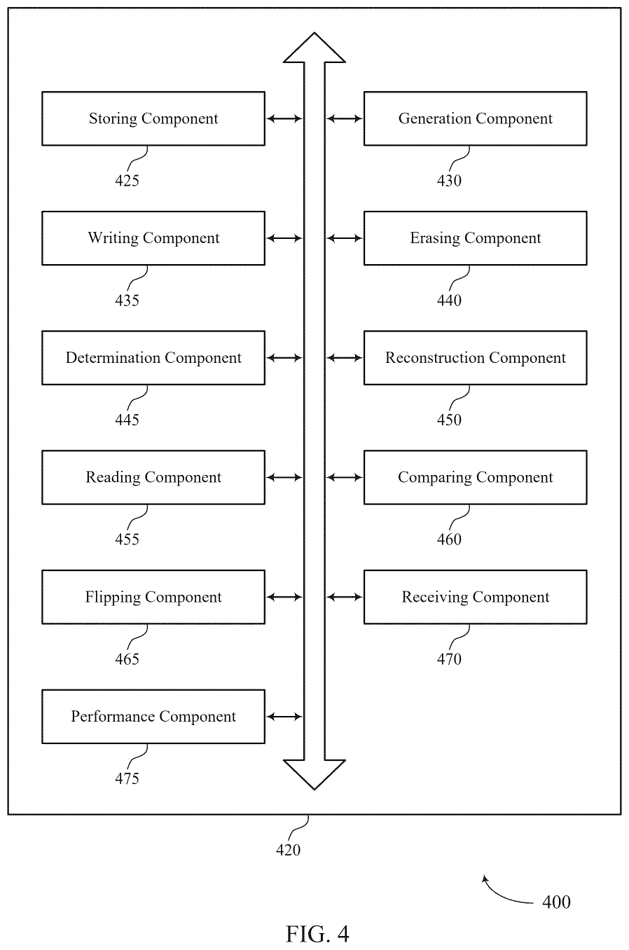

In some instances, at time t₉, the set of parity bits associated with the data (e.g., generated beginning at t₂) may be erased from the parity buffer 220. As described herein and below with reference to FIG. 4, the set of parity bits may be erased based on the associated data being successfully written to the non-volatile memory device 130. In some instances, the data may have been successfully written to the non-volatile memory device 130 without experiencing an error, or the data may have been written to the non-volatile memory device 130 after experiencing one or more errors and being successfully reconstructed using the associated parity bits.

At time t₁₀, the remaining portion of the third data may have been fully transferred to the cache 215, the second sets of parity bits may be still maintained in buffer 220 (e.g., until the end of the second program operation), and the third set of parity bits may have been updated using the last portion of the third data and may be maintained in the parity buffer 220 for a duration that includes the second and third write operations. Accordingly, the timing diagram 200 may be associated with a memory system that can detect and correct programming errors, which may improve its overall performance, without occupying a relatively large buffer space for a relatively long duration.

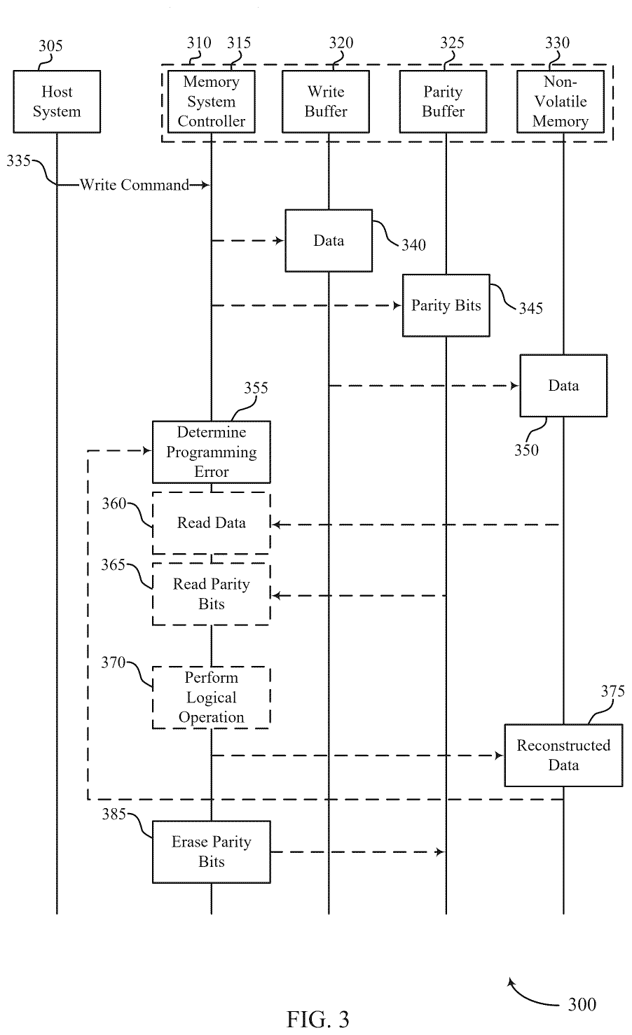

FIG. 3 shows an example of a process 300 that supports data reconstruction by a memory system in accordance with examples as disclosed herein. In some examples, the process 300 may implement or be implemented by aspects of the system 100 or may implement aspects of the timing diagram 200. For example, the process 300 may include a host system 305 and a memory system 310, which may be examples of a host system 105 and a memory system 110 as described with reference to FIG. 1.

Alternative examples of the following may be implemented. Some operations are performed in a different order than described or are not performed at all. In some cases, operations may include additional features not mentioned below, or further operations may be added. Although the host system 305 and the memory system 310 are shown performing the operations of the process 300, some aspects of some operations may also be performed by one or more other systems or devices.

Aspects of the process 300 may be implemented by one or more controllers, among other components. Additionally, or alternatively, aspects of the process 300 may be implemented as instructions stored in one or more memories. For example, the instructions, when executed by one or more controllers, may cause the one or more controllers (or a device or a system) to perform the operations of the process 300.

At 335, a write command may be received. In some examples, the write command may be transmitted by the host system 305 and may be received by the memory system 310. The write command may be received by the memory system controller 315 or another component of the memory system 310 and may include data to be written to the non-volatile memory device 330. In some instances, the write command may include a quantity of data that is less than a page of memory cells (e.g., less than a quantity of data associated with a page of memory cells). In other examples, the data may include at least a first subset of data and a second subset of data.

At 340, the data may be stored to the write buffer 320. In some examples, the memory system controller 315 may store the data to the write buffer 320. The write buffer may be an example of the local memory 120 as described with reference to FIG. 1. That is, the write buffer 320 may include volatile memory cells, such as SRAM cells. The data may be stored (e.g., temporarily stored) to the write buffer 320 while it is written to the non-volatile memory device 330.

At 345, a set of parity bits associated with the data may be generated. In some examples, the memory system controller 315 may generate the set of parity bits and store the set of parity bits to a parity buffer 325. The parity buffer 325 may include volatile memory cells and may be a different buffer than the write buffer 320. The parity bits may be stored to the parity buffer 325 until the associated data is successfully written to the non-volatile memory device 330. In some instances, the set of parity bits may be generated while the write command is received (e.g., concurrent with the write command being received). For example, the parity might be the XOR of N pages (e.g., one page per plane and for all NAND dice; 6 planes 8 dice; N=48) and the parity may be updated as data is received from a host system. In other examples, the data may be sent to the non-volatile memory device as soon as it is received (e.g., as soon as a page is received) so that the non-volatile memory device receives the data before its parity is fully (e.g., completely) calculated.

At 350, the data may be moved (e.g., written) to the non-volatile memory device 330. In some examples, the memory system controller 315 may move the data to the non-volatile memory device 330 by reading it from the write buffer 320 and writing it to one or more non-volatile memory cells of the non-volatile memory device 330. In some examples, the data may be stored to one or more SLCs, MLCs, TLCs, or QLCs. In other examples, the data may be stored to different cursors. Additionally, or alternatively, the data may be stored to a page or a subset of a page.

After the data is transferred to the non-volatile memory device 330, it may be erased from the write buffer 320. Erasing the data from the write buffer 320 may be advantageous, as volatile memory space is both limited and expensive. Thus, erasing the data may free the write buffer 320 relatively quickly for data associated with additional write commands.

At 355, a programming error may be determined. In some examples, the memory system controller 315 may determine whether a programming error occurred during a programming operation (e.g., at 350). For example, the memory system controller 315 may determine whether one or more bit-flips or other types of errors occurred during the programming operation. If an error did not occur, the memory system controller 315 may delete the parity bits stored to the parity buffer 325 at 385 (e.g., the memory system controller may skip 360 to 375). However, if the memory system controller 315 detects an error, the process 300 may proceed to 360.

At 360, data may be read from the non-volatile memory device 330. In some examples, the memory system controller 315 may read the data from the non-volatile memory device 330 based on determining that a programming error occurred (e.g., at 355). For example, if the data received at 335 included a first subset and a second subset, and the first subset incurred an error during a programming operation, the memory system controller 315 may read the second subset of data from the non-volatile memory device 330 at 360. That is, at 360, the memory system controller 315 may read the data that was successfully written to the non-volatile memory device 330.

At 365, the parity bits may be read from the parity buffer 325. In some examples, the memory system controller 315 may read the parity bits from the parity buffer 325 to reconstruct the data that incurred the error.

At 370, a logical operation may be performed on the data and the parity bits. In some examples, the memory system controller 315 may perform a logical operation on the data read from the non-volatile memory device 330 (e.g., at 360) and the parity bits read from the parity buffer 325 (e.g., at 365). For example, the memory system controller 315 may XOR the second subset of data and the set of parity bits to generate (e.g., regenerate, reconstruct) the first subset of data. By performing a logical operation, such as an XOR operation, on the successfully written data and the parity bits, the memory system controller 315 may allow for the missing data to be reconstructed.

Additionally, or alternatively, performing a logical operation on the parity bits and successfully written data may allow for different quantities of data to be reconstructed. For example, if a write command includes data that is less than a page size (e.g., less than a quantity associated with a page of memory cells), its data can still be reconstructed by XOR'ing the generated parity bits and successfully written data. In other examples, if a write command is associated with multiple cursors (e.g., across multiple dies), its data can also be reconstructed by XOR'ing the generated parity bits and successfully written data.

At 375, the reconstructed data may be written to the non-volatile memory device 330. In some examples, the memory system controller 315 may write the first subset of data that was successfully reconstructed (e.g., at 370), to the non-volatile memory device 330. The reconstructed data (e.g., the first subset of data) may be written to the portion of the non-volatile memory device 330 storing the second subset of data (e.g., the successfully written data), which may satisfy the write command. After 375, the process 300 may return to 355 to check whether the program operation 375 was unsuccessful and continue performing 355-375 until the program operation is successful.

At 385, the parity bits may be erased. For example, the memory system controller 315 may erase the parity bits stored to the parity buffer 325 based on the data being successfully written to the non-volatile memory device 330 (e.g., at 350 or 375).

Accordingly, the memory system 310 may detect and correct programming errors, which may improve its overall performance, without occupying a relatively large write buffer 320 space for a relatively long duration.

FIG. 4 shows a block diagram 400 of a memory system 420 that supports data reconstruction by a memory system in accordance with examples as disclosed herein. The memory system 420 may be an example of aspects of a memory system as described with reference to FIGS. 1 through 3. The memory system 420, or various components thereof, may be an example of means for performing various aspects of data reconstruction by a memory system as described herein. For example, the memory system 420 may include a storing component 425, a generation component 430, a writing component 435, an erasing component 440, a determination component 445, a reconstruction component 450, a reading component 455, a comparing component 460, a flipping component 465, a receiving component 470, a performance component 475, or any combination thereof. Each of these components, or components of subcomponents thereof (e.g., one or more processors, one or more memories), may communicate, directly or indirectly, with one another (e.g., via one or more buses).

The storing component 425 may be configured as or otherwise support a means for storing data to a write buffer including volatile memory cells in response to receiving a write command including the data. The generation component 430 may be configured as or otherwise support a means for generating a set of parity bits associated with the data in response to storing the data to the write buffer. The writing component 435 may be configured as or otherwise support a means for writing the data to one or more non-volatile memory cells of the memory system in response to generating the set of parity bits. The erasing component 440 may be configured as or otherwise support a means for erasing the data from the write buffer in response to writing the data to the one or more non-volatile memory cells. The determination component 445 may be configured as or otherwise support a means for determining whether a programming error associated with a first subset of the data occurred in response to writing the data to the one or more non-volatile memory cells. The reconstruction component 450 may be configured as or otherwise support a means for reconstructing the first subset of the data using a second subset of the data and the set of parity bits in response to determining that the programming error associated with the first subset of the data occurred, where the second subset of the data includes data that was successfully written to the one or more non-volatile memory cells.

In some examples, the determination component 445 may be configured as or otherwise support a means for determining that the programming error associated with the first subset of the data did not occur in response to writing the data to the one or more non-volatile memory cells. In some examples, the erasing component 440 may be configured as or otherwise support a means for erasing the set of parity bits in response to determining that the programming error associated with the first subset of the data did not occur.

In some examples, to support reconstructing the first subset of the data, the reading component 455 may be configured as or otherwise support a means for reading the data from the one or more non-volatile memory cells. In some examples, to support reconstructing the first subset of the data, the comparing component 460 may be configured as or otherwise support a means for comparing the data to the set of parity bits. In some examples, to support reconstructing the first subset of the data, the flipping component 465 may be configured as or otherwise support a means for flipping one or more bits of the first subset of the data in response to comparing the data to the set of parity bits.

In some examples, the performance component 475 may be configured as or otherwise support a means for performing a logical operation on the second subset of the data and the set of parity bits.

In some examples, the writing component 435 may be configured as or otherwise support a means for writing the first subset of the data to the one or more non-volatile memory cells in response to reconstructing the first subset of the data.

In some examples, the storing component 425 may be configured as or otherwise support a means for storing the set of parity bits to one or more volatile memory cells of the memory system in response to generating the set of parity bits. In some examples, the erasing component 440 may be configured as or otherwise support a means for erasing the set of parity bits in response to reconstructing the first subset of the data.

In some examples, the receiving component 470 may be configured as or otherwise support a means for receiving a second write command including second data, where generating the set of parity bits is in response to receiving the write command and the second write command, and where the write command is associated with a first memory cursor of the memory system and the second write command is associated with a second memory cursor of the memory system.

In some examples, the data includes a quantity of data that is less than a quantity of data associated with a page of memory cells of the memory system.

In some examples, the data includes the first subset of the data and the second subset of the data.

In some examples, the second subset of the data includes a quantity of programming errors that is less than a threshold value.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

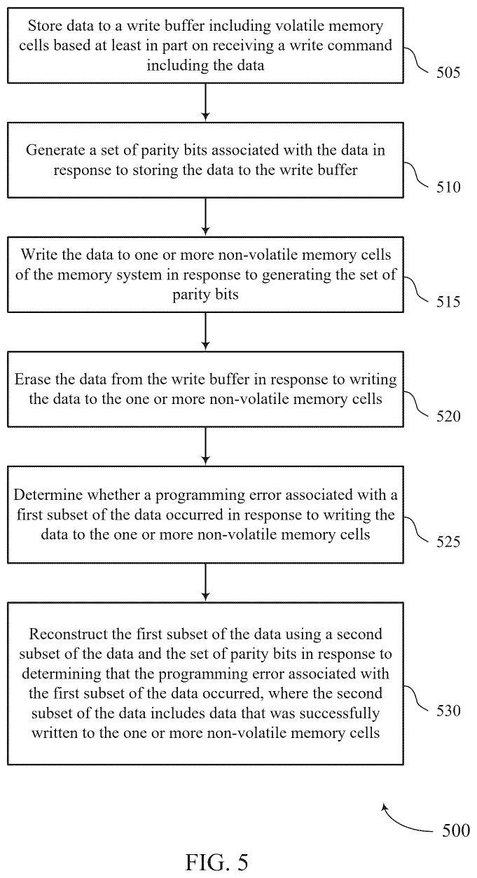

FIG. 5 shows a flowchart illustrating a method 500 that supports data reconstruction by a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include storing data to a write buffer including volatile memory cells in response to receiving a write command including the data. In some examples, aspects of the operations of 505 may be performed by a storing component 425 as described with reference to FIG. 4.

At 510, the method may include generating a set of parity bits associated with the data in response to storing the data to the write buffer. In some examples, aspects of the operations of 510 may be performed by a generation component 430 as described with reference to FIG. 4.

At 515, the method may include writing the data to one or more non-volatile memory cells of the memory system in response to generating the set of parity bits. In some examples, aspects of the operations of 515 may be performed by a writing component 435 as described with reference to FIG. 4.

At 520, the method may include erasing the data from the write buffer in response to writing the data to the one or more non-volatile memory cells. In some examples, aspects of the operations of 520 may be performed by an erasing component 440 as described with reference to FIG. 4.

At 525, the method may include determining whether a programming error associated with a first subset of the data occurred in response to writing the data to the one or more non-volatile memory cells. In some examples, aspects of the operations of 525 may be performed by a determination component 445 as described with reference to FIG. 4.

At 530, the method may include reconstructing the first subset of the data using a second subset of the data and the set of parity bits in response to determining that the programming error associated with the first subset of the data occurred, where the second subset of the data includes data that was successfully written to the one or more non-volatile memory cells. In some examples, aspects of the operations of 530 may be performed by a reconstruction component 450 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for storing data to a write buffer including volatile memory cells in response to receiving a write command including the data; generating a set of parity bits associated with the data in response to storing the data to the write buffer; writing the data to one or more non-volatile memory cells of the memory system in response to generating the set of parity bits; erasing the data from the write buffer in response to writing the data to the one or more non-volatile memory cells; determining whether a programming error associated with a first subset of the data occurred in response to writing the data to the one or more non-volatile memory cells; and reconstructing the first subset of the data using a second subset of the data and the set of parity bits in response to determining that the programming error associated with the first subset of the data occurred, where the second subset of the data includes data that was successfully written to the one or more non-volatile memory cells.
Aspect 2: The method, apparatus, or non-transitory computer-readable medium of aspect 1, further including operations, features, circuitry, logic, means, or instructions, or any combination thereof for determining that the programming error associated with the first subset of the data did not occur in response to writing the data to the one or more non-volatile memory cells and erasing the set of parity bits in response to determining that the programming error associated with the first subset of the data did not occur.
Aspect 3: The method, apparatus, or non-transitory computer-readable medium of any of aspects 1 through 2, where reconstructing the first subset of the data includes operations, features, circuitry, logic, means, or instructions, or any combination thereof for reading the data from the one or more non-volatile memory cells; comparing the data to the set of parity bits; and flipping one or more bits of the first subset of the data in response to comparing the data to the set of parity bits.
Aspect 4: The method, apparatus, or non-transitory computer-readable medium of aspect 3, further including operations, features, circuitry, logic, means, or instructions, or any combination thereof for performing a logical operation on the second subset of the data and the set of parity bits.
Aspect 5: The method, apparatus, or non-transitory computer-readable medium of any of aspects 1 through 4, further including operations, features, circuitry, logic, means, or instructions, or any combination thereof for writing the first subset of the data to the one or more non-volatile memory cells in response to reconstructing the first subset of the data.
Aspect 6: The method, apparatus, or non-transitory computer-readable medium of any of aspects 1 through 5, further including operations, features, circuitry, logic, means, or instructions, or any combination thereof for storing the set of parity bits to one or more volatile memory cells of the memory system in response to generating the set of parity bits and erasing the set of parity bits in response to reconstructing the first subset of the data.
Aspect 7: The method, apparatus, or non-transitory computer-readable medium of any of aspects 1 through 6, further including operations, features, circuitry, logic, means, or instructions, or any combination thereof for receiving a second write command including second data, where generating the set of parity bits is in response to receiving the write command and the second write command, and where the write command is associated with a first memory cursor of the memory system and the second write command is associated with a second memory cursor of the memory system.
Aspect 8: The method, apparatus, or non-transitory computer-readable medium of any of aspects 1 through 7, where the data includes a quantity of data that is less than a quantity of data associated with a page of memory cells of the memory system.
Aspect 9: The method, apparatus, or non-transitory computer-readable medium of any of aspects 1 through 8, where the data includes the first subset of the data and the second subset of the data.
Aspect 10: The method, apparatus, or non-transitory computer-readable medium of aspect 9, where the second subset of the data includes a quantity of programming errors that is less than a threshold value.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
store data to a write buffer comprising volatile memory cells in response to receiving a write command comprising the data;
generate a set of parity bits associated with the data in response to storing the data to the write buffer;
write the data to one or more non-volatile memory cells of the memory system in response to generating the set of parity bits;
erase the data from the write buffer in response to writing the data to the one or more non-volatile memory cells;
determine whether a programming error associated with a first subset of the data occurred in response to writing the data to the one or more non-volatile memory cells; and
reconstruct the first subset of the data using a second subset of the data and the set of parity bits in response to determining that the programming error associated with the first subset of the data occurred, wherein the second subset of the data comprises data that was successfully written to the one or more non-volatile memory cells.

2. The memory system of claim 1, wherein the processing circuitry is further configured to cause the memory system to:
determine that the programming error associated with the first subset of the data did not occur in response to writing the data to the one or more non-volatile memory cells; and
erase the set of parity bits in response to determining that the programming error associated with the first subset of the data did not occur.

3. The memory system of claim 1, wherein reconstructing the first subset of the data comprises the processing circuitry configured to cause the memory system to:
read the data from the one or more non-volatile memory cells;
compare the data to the set of parity bits; and
flip one or more bits of the first subset of the data in response to comparing the data to the set of parity bits.

4. The memory system of claim 3, wherein the processing circuitry is further configured to cause the memory system to:
perform a logical operation on the second subset of the data and the set of parity bits.

5. The memory system of claim 1, wherein the processing circuitry is further configured to cause the memory system to:
write the first subset of the data to the one or more non-volatile memory cells in response to reconstructing the first subset of the data.

6. The memory system of claim 1, wherein the processing circuitry is further configured to cause the memory system to:
store the set of parity bits to one or more volatile memory cells of the memory system in response to generating the set of parity bits; and
erase the set of parity bits in response to reconstructing the first subset of the data.

7. The memory system of claim 1, wherein the processing circuitry is further configured to cause the memory system to:
receive a second write command comprising second data, wherein generating the set of parity bits is in response to receiving the write command and the second write command, and wherein the write command is associated with a first memory cursor of the memory system and the second write command is associated with a second memory cursor of the memory system.

8. The memory system of claim 1, wherein the data comprises a quantity of data that is less than a quantity of data associated with a page of memory cells of the memory system.

9. The memory system of claim 1, wherein the data comprises the first subset of the data and the second subset of the data.

10. The memory system of claim 9, wherein the second subset of the data comprises a quantity of programming errors that is less than a threshold value.

11. A non-transitory computer-readable medium storing code comprising instructions which, when executed by one or more processors of a memory system, cause the memory system to:
store data to a write buffer comprising volatile memory cells in response to receiving a write command comprising the data;
generate a set of parity bits associated with the data in response to storing the data to the write buffer;
write the data to one or more non-volatile memory cells of the memory system in response to generating the set of parity bits;
erase the data from the write buffer in response to writing the data to the one or more non-volatile memory cells;
determine whether a programming error associated with a first subset of the data occurred in response to writing the data to the one or more non-volatile memory cells; and
reconstruct the first subset of the data using a second subset of the data and the set of parity bits in response to determining that the programming error associated with the first subset of the data occurred, wherein the second subset of the data comprises data that was successfully written to the one or more non-volatile memory cells.

12. The non-transitory computer-readable medium of claim 11, wherein the instructions, when executed by the one or more processors of the memory system, further cause the memory system to:
determine that the programming error associated with the first subset of the data did not occur in response to writing the data to the one or more non-volatile memory cells; and
erase the set of parity bits in response to determining that the programming error associated with the first subset of the data did not occur.

13. The non-transitory computer-readable medium of claim 11, wherein the instructions to reconstruct the first subset of the data, when executed by the one or more processors of the memory system, further cause the memory system to:
read the data from the one or more non-volatile memory cells;
compare the data to the set of parity bits; and
flip one or more bits of the first subset of the data in response to comparing the data to the set of parity bits.

14. The non-transitory computer-readable medium of claim 13, wherein the instructions, when executed by the one or more processors of the memory system, further cause the memory system to:
perform a logical operation on the second subset of the data and the set of parity bits.

15. The non-transitory computer-readable medium of claim 11, wherein the instructions, when executed by the one or more processors of the memory system, further cause the memory system to:
write the first subset of the data to the one or more non-volatile memory cells in response to reconstructing the first subset of the data.

16. The non-transitory computer-readable medium of claim 11, wherein the instructions, when executed by the one or more processors of the memory system, further cause the memory system to:
store the set of parity bits to one or more volatile memory cells of the memory system in response to generating the set of parity bits; and
erase the set of parity bits in response to reconstructing the first subset of the data.

17. The non-transitory computer-readable medium of claim 11, wherein the instructions, when executed by the one or more processors of the memory system, further cause the memory system to:
receive a second write command comprising second data, wherein generating the set of parity bits is in response to receiving the write command and the second write command, and wherein the write command is associated with a first memory cursor of the memory system and the second write command is associated with a second memory cursor of the memory system.

18. The non-transitory computer-readable medium of claim 11, wherein the data comprises a quantity of data that is less than a quantity of data associated with a page of memory cells of the memory system.

19. The non-transitory computer-readable medium of claim 11, wherein the data comprises the first subset of the data and the second subset of the data.

20. The non-transitory computer-readable medium of claim 19, wherein the second subset of the data comprises a quantity of programming errors that is less than a threshold value.

21. A method by a memory system, comprising:
storing data to a write buffer comprising volatile memory cells in response to receiving a write command comprising the data;
generating a set of parity bits associated with the data in response to storing the data to the write buffer;
writing the data to one or more non-volatile memory cells of the memory system in response to generating the set of parity bits;
erasing the data from the write buffer in response to writing the data to the one or more non-volatile memory cells;
determining whether a programming error associated with a first subset of the data occurred in response to writing the data to the one or more non-volatile memory cells; and
reconstructing the first subset of the data using a second subset of the data and the set of parity bits in response to determining that the programming error associated with the first subset of the data occurred, wherein the second subset of the data comprises data that was successfully written to the one or more non-volatile memory cells.

22. The method of claim 21, further comprising:
determining that the programming error associated with the first subset of the data did not occur in response to writing the data to the one or more non-volatile memory cells; and
erasing the set of parity bits in response to determining that the programming error associated with the first subset of the data did not occur.

23. The method of claim 21, wherein reconstructing the first subset of the data comprises:
reading the data from the one or more non-volatile memory cells;
comparing the data to the set of parity bits; and
flipping one or more bits of the first subset of the data in response to comparing the data to the set of parity bits.

24. The method of claim 23, further comprising:
performing a logical operation on the second subset of the data and the set of parity bits.

25. The method of claim 21, further comprising:
writing the first subset of the data to the one or more non-volatile memory cells in response to reconstructing the first subset of the data.
